(19) United States
(12) Patent Application Publication
(10) Pub. No.: US 2024/0299891 A1
(43) Pub. Date: Sep. 12, 2024

(54) CHEMICAL DELIVERY SYSTEM WITH DILUTION CONTROL

(71) Applicant: Sonny's HFI Holdings, LLC, Wilmington, DE (US)

(72) Inventors: Ken Martin, Little Canada, MN (US); Andrew Edmunds, Woodbury, MN (US); Connor Findlay, Shakopee, MN (US); Pa Mong Xiong, Maplewood, MN (US); Daniel Folk, River Falls, WI (US); Nathan Schlueter, Bloomington, MN (US); Brandon Hoffman, Shakopee, MN (US); Tony Geisler, Maple Grove, MN (US)

(21) Appl. No.: 18/596,979

(22) Filed: Mar. 6, 2024

Related U.S. Application Data
(60) Provisional application No. 63/451,257, filed on Mar. 10, 2023.

(51) Int. Cl. B01F 35/22; A01C 23/00; A01C 23/04; A01M 7/00; B01F 25/312; B01F 35/21; B01F 35/221; B01F 35/71; B01F 101/32

(52) U.S. Cl. CPC B01F 35/2202; A01C 23/007; A01C 23/047; A01M 7/0032; A01M 7/0092; B01F 25/31243; B01F 35/21112; B01F 35/2211; B01F 35/7176; B01F 35/71805; B01F 2101/32

(57) ABSTRACT

A chemical delivery system with dilution control includes a chemical delivery manifold with eductors each fluidly coupled to a valve configured to operate independently to selectively control flow of a motive fluid through a respective eductor. Metering devices are coupled to concentrated chemical lines and configured to control a rate of dispensing of the concentrated chemical passing therethrough to each of the eductors. Concentrated chemical flow rate sensors are coupled to each of these individual concentrated chemical lines and configured to measure a flow rate of the concentrated chemicals therethrough. A control unit receives a measured flow rate from each flow rate sensor and causes a respective metering device to adjust the rate of dispensing for one or more concentrated chemicals to control the flow rates of the concentrated chemicals and thereby individually control a dilution of each concentrated chemical in the motive fluid.

### CROSS-REFERENCE TO RELATED APPLICATIONS

This application claims priority to U.S. Provisional Patent Application No. 63/451,257, filed Mar. 10, 2023, entitled “Chemical Delivery System with Dilution Control,” which is incorporated by reference herein, in the entirety and for all purposes.

### TECHNICAL FIELD

Dilution control systems measure flow rates and control dilution rates of mixed solutions.

### BACKGROUND

Concentrated chemicals are diluted with water prior to their application, and the dilution rate is controlled by metering devices that deliver concentrated chemical in metered amounts. The amount of chemical dispensed per volume of water can be established based on setting a flow rate of a metering device, resulting in an intended dilution rate, and the metering devices may be adjusted, such as by turning a metering dial, to adjust the metering rate of the chemical dispensed to reach a desired dilution rate. Metering devices typically operate based on a dilution curve where each of the predefined settings of the metering device correspond to an amount of product dispensed by the metering device.

### SUMMARY

Provided are chemical delivery systems with dilution control.

According to certain implementations, a chemical delivery system with dilution control may include a chemical delivery manifold with a manifold body including an inlet port fluidly coupled to a plurality of eductors. Each eductor may include a motive fluid inlet, a concentrated chemical inlet, and a mixed solution outlet. The motive fluid inlet may be fluidly coupled to the inlet port and to a valve configured to be operated by a control signal such that each valve may be operated independently to selectively control flow of a motive fluid through a respective motive fluid inlet of an eductor of the plurality of eductors. The concentrated chemical inlet may be fluidly connected to a concentrated chemical by a concentrated chemical line such that each eductor may be configured to individually mix a corresponding concentrated chemical into the motive fluid to form a mixed solution therein. A plurality of metering devices may each be coupled to a corresponding concentrated chemical line and configured to control a rate of dispensing of the concentrated chemical passing through the corresponding concentrated chemical line. A plurality of concentrated chemical flow rate sensors may each be coupled to the corresponding concentrated chemical line and configured to measure a flow rate of the concentrated chemical through the corresponding concentrated chemical line. A control unit may include processor configured to receive a measured flow rate from each flow rate sensor of the plurality of flow rate sensors, and to cause a respective metering device of the plurality of metering devices to adjust the rate of dispensing for one or more of the concentrated chemicals to thereby control the flow rate of the one or more of the concentrated chemicals such that a dilution of each concentrated chemical in the motive fluid may be individually controlled.

In various implementations and alternatives, the plurality of eductors may configured as venturi eductors, such that the concentrated chemical is drawn through the concentrated chemical inlet by the venturi effect. In such cases, the control unit may be configured to receive data from each flow rate sensor of the plurality of flow rate sensors corresponding to an actual flow rate, and when the control unit determines a target flow rate differs from the actual flow rate, the control unit may cause a corresponding metering device of the plurality of metering devices to adjust the rate of dispensing of the concentrated chemical into the concentrated chemical inlet. In further cases, the corresponding metering device of the plurality of metering devices may be configured to adjust an orifice size of the concentrated chemical line, and when the control unit determines the target flow rate differs from the actual flow rate, the control unit may cause the corresponding metering device of the plurality of metering devices to adjust the orifice size of the concentrated chemical line.

In various implementations and alternatives, the manifold body may include a common inlet channel fluidly coupled to each of the valves and to each of the motive fluid inlets of the plurality of eductors. In addition or alternatively, the motive fluid may be delivered at a constant pressure through each valve, and for instance, the motive fluid may be delivered by a supply pump. In some cases, the valve may be a pneumatic valve or a solenoid valve.

In various implementations and alternatives, in response to receiving the measured flow rate from each flow rate sensor, the control unit may be further configured to adjust the control signal for operating the valves coupled to the motive fluid inlet of the eductor.

In addition or alternatively, the system may further include a distribution manifold with an inlet port and a plurality of distribution ports, and at least one of the plurality of distribution ports may deliver the motive fluid to the inlet port of the chemical delivery manifold. For instance, the chemical delivery system may include at least two chemical delivery manifolds, and the plurality of distribution ports may deliver the motive fluid to each inlet port of the at least two chemical delivery manifolds.

In addition or alternatively, the system may further include a plurality of fluid delivery lines, each coupled to an individual mixed solution outlet, and the plurality of fluid delivery lines may be configured to direct the mixed solution to an application area. In some cases, each fluid delivery line may be fluidly coupled to a mixed solution distribution port and configured to deposit the individual mixed solution at the application area.

According to other implementations, a method of delivering a mixed solution from a chemical delivery system configured with dilution control may involve: receiving, by a control unit having a processor, measured flow rates from a plurality of flow rate sensors of the chemical delivery system. Each of the plurality of flow rate sensors may be coupled to a corresponding concentrated chemical line and configured to measure a flow rate of a concentrated chemical therethrough. Each concentrated chemical line may be fluidly coupled to a concentrated chemical inlet of an eductor of a plurality of eductors, and each of the plurality of eductors may be fluidly coupled to an inlet port of a chemical delivery manifold via a motive fluid inlet thereof. The eductor motive fluid inlet may be fluidly coupled to a valve of a plurality of valves, and each of the plurality of eductors may include a mixed solution outlet. The method may proceed by transmitting, by the control unit, instructions to cause at least one metering device of a plurality of metering devices to adjust a rate of dispensing of the concentrated chemical through the corresponding concentrated chemical line for at least one of the concentrated chemicals based on the measured flow rates, where each of the plurality of metering devices may be coupled to the corresponding concentrated chemical lines and configured to control a rate of dispensing of the concentrated chemical passing therethrough. The method may proceed by transmitting, by the control unit, a control signal to cause each valve of the plurality of valves to be operated, such that each valve may be operated independently to selectively control flow of a motive fluid through a respective motive fluid inlet of an eductor of the plurality of eductors such that each eductor may be configured to individually mix the concentrated chemical into the motive fluid to form a mixed solution having a controlled flow rate of the concentrated chemical to thereby individually control a dilution of each concentrated chemical in the motive fluid.

In various implementations and alternatives, the method may further involve determining, by the control unit, that the measured flow rate from one or more flow rate sensors differs from a target flow rate; and based on the determination, causing, by the control unit, one or more corresponding metering devices of the plurality of metering devices to adjust the rate of dispensing of the concentrated chemical.

### BRIEF DESCRIPTION OF THE DRAWINGS

FIGS. 1A and 1B illustrate dilution control systems for monitoring and controlling dilution operations for use in fluid delivery systems, according to the present disclosure.

FIG. 2 illustrates another dilution control system, according to the present disclosure.

FIG. 3 illustrates is a dilution control system additionally configured for mixing and reconstitution.

FIG. 4 is a flow chart illustrating a method of delivering a mixed solution from a chemical delivery system configured with dilution control, according to the present disclosure.

### DETAILED DESCRIPTION

Due to the variability in the operation of metering devices, for instance, due to changes in performance over the lifespan of metering devices or across different models or types of metering devices, actual dilution rates of the chemical may differ from the dilution rate intended to be delivered by the metering device's settings. It is therefore necessary to identify approaches in which actual dilution rates may be accurately calculated so that metering devices can be adjusted to meter the dispensed chemical to result in an intended dilution rate.

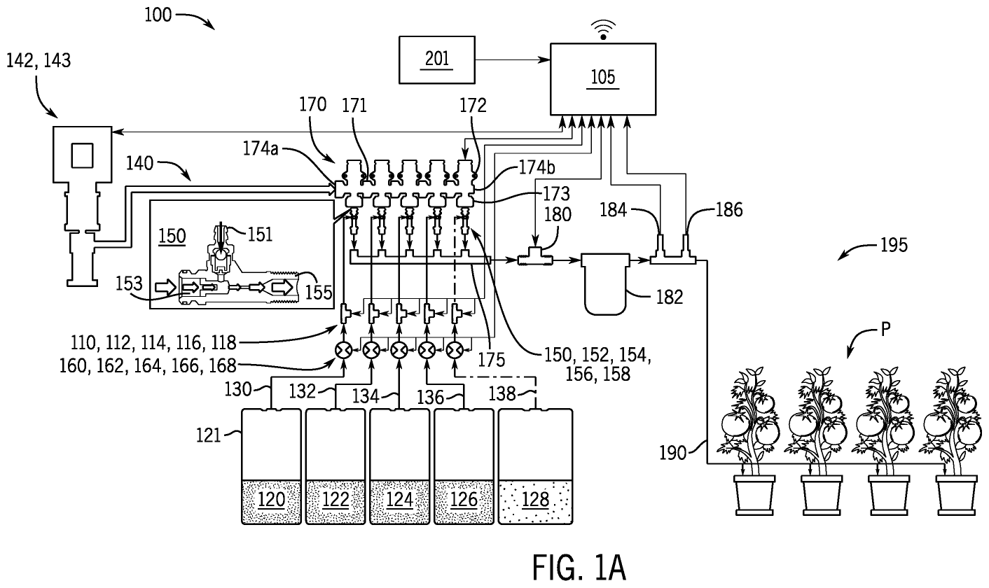

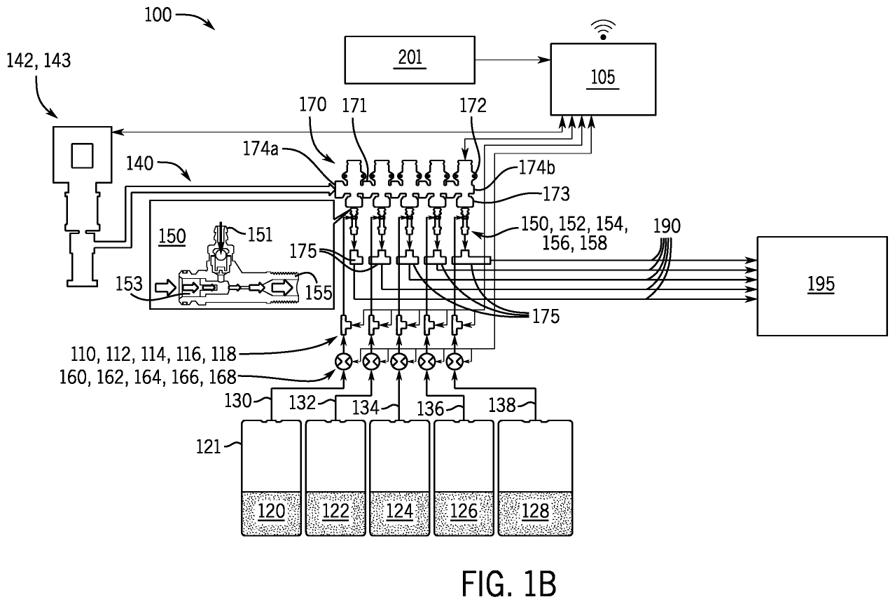

Turning to FIGS. 1A and 1B, implementations provide a dilution control system 100 configured to monitor and control dilution operations for use in fluid delivery systems according to the present disclosure. The dilution control system 100 may include a control unit 105, flow rate sensors 110, 112, 114, 116, and 118 (e.g., chemical in-flow meters), a plurality of concentrated chemicals 120, 122, 124, 126, and 128 (e.g., agricultural inputs such as nutrients and fertilizers, and pH adjusters) within respective in-feed lines 130, 132, 134, 136, 138, a water inlet line 140, a pump 142, eductors 150, 152, 154, 156, 158 (e.g., a chemical injector), each including a concentrated chemical inlet 151 (e.g., for receiving undiluted chemical), a water inlet 153, and a mixed solution outlet 155, metering devices 160, 162, 164, 166, and 168 (e.g., pinch valves, needle valves, positive displacement pumps), a chemical delivery manifold 170 (e.g., water manifold), a mixed solution line 175, a mixed solution flow rate sensor 180 (e.g., flow meter outlet flow), a mixing tank 182 (e.g., mixer), a pH sensor 184, an electrical conductivity sensor 186 (e.g., EC sensor), and one or more mixed solution ports or fluid distribution ports 190 such as fluid delivery nozzles.

The components of the dilution control system 100 may be housed within the same location where solutions are diluted in motive fluid (e.g., pumped water) and applied to a target or target area. For instance, the dilution control system 100 may be arranged within controlled environment agriculture such as indoor horticultural facility for growing operations, or in a cleaning facility such as at a car wash. Diluted solutions may thus be delivered to application areas 195 such as to soil, seed, or plants in a greenhouse or to vehicles in a vehicle wash location.

The control unit 105 of the dilution control system 100 generally includes a processor and memory communicatively coupled to various components of the dilution control system 100 and is configured receive information therefrom and send control signals thereto. For instance, the control unit 105 may be communicatively coupled to the flow rate sensors 110-118 and may receive data corresponding to sensed flow rates of the concentrated chemicals passing through each of the respective in-feed lines 130-138. The metering devices 160-168 may each be configured to send metering device settings to the control unit 105, which may correspond to a target metering rate of the metering device, and the control unit 105 may be configured to send individual control signals to each of the metering devices to enable individual control of a respective metering device, for instance, when an actual flow rate of the metering device does not correspond to a target flow rate. The chemical delivery manifold 170 may be communicatively coupled to the control unit 105 and may receive control signals for operation of the actuators of the manifold. The mixed solution flow rate sensor 180, the pH sensor 184, and the electrical conductivity sensor 186 may each be configured to send data corresponding to a sensed flow rate of a mixed solution, a sensed pH, and electrical conductivity, respectively, to the control unit 105, which may use such information to control operations of the dilution control system 100.

The flow rate sensors 110-118 of the dilution control system 100 may be configured to sense a flow rate of each of a respective plurality of concentrated chemicals 120-128 within respective in-feed lines 130-138 prior to the concentrated chemical 120-128 reaching the eductors 150-158 and mixing with a motive fluid, e.g., pressurized water, delivered via the water inlet line 140 of the dilution control system 100. The flow rate sensors 110-118 may be coupled to the in-feed lines 130-138, e.g., via a coupler such as a clamp, and may be positioned upstream or downstream of the metering devices 160-168. The flow rate sensors 110-118 may be configured as ultrasonic flow meters that use sound waves to detect a velocity of fluid flowing through the in-feed lines 130-138 to determine a volumetric flow therethrough.

The concentrated chemicals 120-128 may be selected based on their application of use, and for instance may include agricultural inputs when the dilution control system 100 is used in connection with controlled environment agriculture for irrigating and providing nutrients and fertilizers to plants, such as in indoor agricultural operations such as hydroponics, vertical farming units, growing crop plants such as tomatoes, lettuce, cannabis, and in field testing. Agricultural inputs may include nitrogen, phosphorous and potassium (e.g., NPK) nutrients (e.g., urea as a source of nitrogen, phosphates such as potassium phosphate (KH₂PO₄) or sodium phosphate (Na₃PO₄), and potassium chloride (KCl) (e.g., K⁺)), pH adjusters (e.g., acids such as phosphoric acid and potassium hydroxide), sodium chloride (NaCl) (e.g., Na⁺), water softening agents, herbicides, fungicides, and insecticides. Concentrated chemicals 120-128 may also include concentrated detergents, ion exchange concentrates, water softening agents for instance in vehicle wash operations. Other concentrated chemicals may include but are not limited to biocides and disinfectants, and various applications of use may additionally include reverse osmosis, water softening, and water reclamation.

The in-feed lines 130-138, also referred to as concentrated chemical lines, may carry a respective concentrated chemical 120-128 from a bulk concentrated chemical supply, such as a barrel 121, to a respective eductor of the eductors 150-158, and may be adapted to receive a respective flow rate sensor of the flow rate sensors 110-118 and a respective metering device of the metering devices 160-168. In some implementations, the in-feed lines may be constructed of materials adapted to withstand degradation by the concentrated chemicals and/or may be adapted to protect the concentrated chemicals from degradation such from UV-light, from bacterial growth, or from high or low temperatures. For instance, one or more of the in-feed lines may be opaque to prevent penetration of UV-light and/or bacterial growth, may be insulated to maintain a desired temperature range, and so on.

The water inlet line 140 may be configured to transport pressurized motive fluid to the dilution control system 100. In some implementations, motive fluid may be delivered at a constant pressure through each valve 173 of the chemical delivery manifold. For instance, the pump 142, also referred to as a supply pump, may provide fluid pressure, such as constant fluid pressure, to the motive fluid within the water inlet line 140 and to a fluid inlet of the chemical delivery manifold 170. The pump 142 may be communicatively coupled to the control unit 105, and for instance, in response control signals from the control unit 105, the pump 142 may deliver fluid pressure over a pre-determined timing cycle to the chemical delivery manifold 170. In some cases, the pump 142 may provide supplemental water pressure to the dilution control system 100, which may otherwise receive pressurized water from another water supply such as a municipal water supply. Alternatively, the pump 140 may provide the sole source of pressure to the chemical delivery manifold 170. The pump 142 may also provide pressure to the concentrated chemicals 120-128, however, transport of the concentrated chemicals 120-128 within the in-feed lines 130-138 may additionally or alternatively rely on vacuum pressure for delivery of the concentrated chemicals into the eductors 150-158 as provided herein. The pump 142 may include a processor 143 communicatively coupled to the processor of the control unit 105 and operation of the pump 142 may be controlled through communications between such processors.

The eductors 150-158 may be coupled to corresponding in-feed lines 130-138 and each eductor of the eductors 150-158 may be configured to receive concentrated chemicals at a concentrated chemical inlet 151, receive motive fluid at a water inlet 153, and deliver a mixed solution via a mixed solution outlet 155. The eductors 150-158 of the present disclosure may have a venturi configuration for introducing the concentrated chemical into the motive fluid. The eductors 150-158 may each be coupled to the chemical delivery manifold 170 using quick-connect mechanisms such as bayonet fittings, pin couplers, and so on, and each eductor may be individually replaceable or exchangeable for eductors having different flow ratings. The venturi configuration of the eductors 150-158 draws a concentrated chemical 120-128 in through a respective concentrated chemical inlet 151 of each eductor by the venturi effect and mixes the chemical with the motive fluid provided at the water inlet 153, e.g., port of the eductor, which may be fluidly coupled to an inlet port defined in the chemical delivery manifold 170. Venturi eductors of various sizes and configurations produce various suction pressures at the concentrated chemical inlet 151. The selection of individual eductors 150-158 is generally based on the desired chemical concentration, along with the flow rate and/or pressure of the motive fluid through the chemical delivery manifold 170. The resulting mixed solution in the eductor is then directed to the mixed solution outlet 155 of the eductor. Due to venturi configuration providing a differential between the inlet and outlet pressures during operation of the dilution control system 100, the eductors 150-158 draw in the respective concentrated chemical 120-128 as the motive fluid enters the eductor, thus enabling the addition of concentrated chemicals into the delivery system using suction or vacuum force, which differs from other chemical delivery systems that rely on pumps for the delivery of concentrated chemicals into a mixed solution. In addition, the use of eductors having a venturi configuration avoids exposing moving parts to the concentrated chemicals such that issues regarding chemical compatibility and wear can be avoided.

Metering devices 160-168 (e.g., pinch valves, needle valves, and positive displacement pumps) may be associated with a respective in-feed lines 130-138 and configured to be adjustable to for instance increase or decrease a flow rate from a respective in-feed line 130-138 to a respective eductor 150-158 based on the sensed flow rate for a corresponding concentrated chemical 120-128. Metering devices 160-168 may include, for example, a solution inlet of a fluid chamber with an adjustable orifice supplying the solution to the solution inlet. The orifice opening may be adjusted to reach the target flow rate of a respective concentrated chemical. For example, the metering devices 160-168 may be configured as a pinch valve or a needle valve in which an orifice may be widened or narrowed to permit more or less concentrated chemical to pass through the in-feed lines 130-138 and into a respective eductor 150-158 to adjust a metering rate of the concentrated chemical. In addition or alternatively, the metering devices 160-168 may include a positive displacement pump such as a peristaltic pump that may positively displace fluid over an impingement path, and the rate of fluid displacement may be adjusted to increase or decrease a rate of solution delivery from the in-feed lines 130-138. Adjusting the rate of displacement may be through adjusting a rotation rate of one or more rollers of the peristaltic pump. Accordingly, in this example, the peristaltic pump may be configured to impinge on the in-feed lines 130-138, where a rate of displacement of the solution from the in-feed lines 130-138 may be adjusted to change a metering rate of the concentrated chemical.

The chemical delivery manifold 170 may be configured with a manifold body 171 that may hold actuators 172 for controlling valves 173, e.g., pneumatic valves or solenoid valves, which may open and close motive fluid paths coupled to the eductors 150. For instance, the chemical delivery manifold 170 may include one or more valves, each operatively connected to an eductor of the eductors 150-158. By controlling an on/off status of the valve(s), fluid flow may be controlled through the eductors. In examples, upon operation of individual valves 173, such as by the control unit 105 sending a control signal to operate the valves 173, motive fluid from the water inlet line 140 may be delivered to corresponding motive fluid inlets 153 of one or more eductors 150-158, and the motive fluid entering the eductor may cause a concentrated chemical to be drawn into the chemical inlet 151 of the eductor such that the motive fluid and concentrated mix with in their respective eductor, and the individual mixed solutions may each exit a mixed solution outlet 155 of each respective eductor 150-158. The chemical delivery manifold 170 may be configured as a bank of valves and injectors in a dispensing panel and may be responsible for distributing mixed solutions from a plurality of eductors coupled to the bank of actuators in response to receiving control signals from the control unit 105 of the dilution control system 100. In some examples, the manifold body 171 includes an inlet port 174a of a common inlet channel 174b fluidly coupled to each of the valves 173 and to each of the motive fluid inlets 153 of the plurality of eductors 150-158. FIG. 1A illustrates a detail view of the eductor 150 and its mixed solution outlet 155, and this outlet 155 feeds to a common mixed solution line 175 where each of the mixed solutions of the eductors 150-158 is combined to form a common mixture of a plurality of diluted chemicals. However, it will be understood that mixed solution outlets 155 of the eductors 150-158 may instead be fluidly coupled to a mixed solution delivery line 175 holding a single or individual mixed solution from one eductor, and the mixed solution from the single eductor may be directed to an application area 195 as shown in FIG. 1B. In another example, a combination of fewer than all of the mixed solutions may be combined in a mixed solution delivery line 175 and directed to an application area 195 (e.g., a combination of two, three, or four mixed solutions). In some implementations, the mixed solution delivery line 175 may be constructed of materials adapted to withstand degradation by the mixed solutions and/or may be adapted to protect the mixed solutions from degradation such from UV-light, from bacterial growth, or from high or low temperatures as described herein. In addition or alternatively, mixed chemical lines leading from the outlet 155 of the eductors 150-158 to the mixed solution delivery line 175 may be constructed of such materials.

The mixed solution flow rate sensor 180 (flow meter outlet flow) may optionally be provided in the dilution control system 100 for instance when configured to deliver a common supply of a plurality of mixed solutions, such as in agricultural or horticultural operations where a single recipe of multiple agricultural inputs (e.g., an NPK input), water and optionally pH adjusters are deposited, e.g., sprayed, onto soil, seeds, foliage and/or fruit. The mixed solution flow rate sensor 180 may be configured as an ultrasonic flow meter that uses sound waves to detect a velocity of fluid flowing through the mixed solution line 175 to determine a volumetric flow therethrough. The mixed solution flow rate sensor 180 may sense a flow rate of the mixed fluids moving through the mixed solution line 175 and may provide data corresponding to the sensed flow rate to the control unit 105 for use in controlling the metering devices 160-168.

The mixing tank 182 (mixer) may receive the diluted concentrated chemicals from the mixed solution line 175 and may serve as a conditioning and a mixing tank to, for instance, thoroughly mix the diluted concentrated chemicals prior to application.

The pH sensor 184 may optionally be provided in the dilution control system 100 for instance when a pH of the mixture is to be controlled, such as when the mixed solutions are applied in agricultural or horticultural operations where soil and plants require inputs to be pH controlled. For instance, the pH sensor 184 may be configured to sense a pH, e.g., an actual or real-time pH of a combined mixed solution, and may send data corresponding to the sensed pH data to the control unit 105, which may determine whether or not a target pH differs from the sensed pH and use the information when operating components of the dilution control system 100. For instance, as shown in FIG. 1A, one or more of the concentrated chemicals 128 may include a pH adjuster, such as pH adjuster transported by or at the in-feed line 138, optionally referred to as a pH adjustment line, and metered by the metering device 168. Where a target pH has not yet been achieved, the control unit 105 may cause the metering device 168 to adjust the metering rate of the pH adjuster 128 to thereby adjust the pH of the combined mixed solution in the mixed solution line 175 to reach the target pH.

The electrical conductivity sensor 186 (e.g., EC sensor) may measure electrical conductivity of the diluted concentrated chemicals after being mixed in the solution line 175 and/or the mixing tank 182. For instance, as the dilution increases in the mixed solution, the conductivity is reduced, whereas the higher concentration of solution in the mixed solution results in an increased conductivity. The electrical conductivity sensor 186 may be configured to sense a range of electrical conductivity of 0 to 200 mS/cm in the mixed solution, and the dilution of the concentrated chemical may be calculated based thereon for use in accurately metering the concentrated chemical into the motive fluid. In some examples, the electrical conductivity may be used in connection with applying mixed solutions of one or more agricultural inputs in agricultural or horticultural operations where certain electrical conductivities are targeted based on the stage of plant growth. The control unit 105 may receive measurements form the electrical conductivity sensor 186 and determine whether or not the conductivity is at a target level. In some cases, the control unit 105 may signal a user that the conductivity level requires modification, and a user may adjust a flow rate of one or more of the concentrated chemicals 120-128 by adjusting a corresponding metering device of the metering devices 160-168. In addition or alternatively, when the control unit 105 determines the electrical conductivity differs from a target electrical conductivity, the control unit 105 may cause one or more metering devices of the metering devices 160-168 to adjust the flow rate of the concentrated chemical through the concentrated chemical line to thereby adjust the electrical conductivity of the combined mixed solution.

The one or more mixed solution ports or fluid distribution ports 190 may be configured as fluid delivery nozzles. For instance in implementations where a combined mixed solution is transmitted by the mixed solution line 175, this solution may be a combination of a plurality of diluted agricultural inputs (e.g., diluted NPK inputs, diluted plant nutrients, diluted fertilizers), and such common solutions may be delivered from a plurality of agricultural spray nozzles to a plurality of plants P as illustrated in FIG. 1A. In other implementations such as where one or more of the mixed solution outlets 155 of the eductors 150-158 are instead directed to an application area 195 where an individual mixed solution is applied as illustrated in FIG. 1B, the dilution control system 100 and its fluid distribution ports 190 may be configured to deposit the individual mixed solution and may be selected for deposition of the individual solution. For instance, the port 190 may deliver a spray, a foam, a stream of fluid, an oscillating spray pattern, and so on. In addition or alternatively, a combination of fewer than all of the mixed solutions may be applied (e.g., a combination of two, three, or four mixed solutions) via the dilution control system 100 and its fluid distribution ports 190. In such examples, an appropriate fluid delivery lines may be fluidly coupled between the mixed solution outlets 155 of the eductors 150-158 and the fluid distribution ports 190.

Associating each of the flow rate sensors 110-118 with a respective concentrated chemical in-feed line 130-138 enables precise amounts of the concentrated chemicals 120-128 to be dispensed into the dilution control system 100 as provided herein. This provides advantages over systems that do not include a flow rate sensor in combination with metering devices, particularly because while metering devices typically dispense product at rates determined by a manufacturer's lab data, there is no way to confirm the actual delivery rates of the metering device once installed. More particularly, by the control unit 105 receiving a measured flow rate from each flow rate sensor 110-118, the control unit 105 may cause a respective metering device 160-168 to adjust a rate of dispensing of one or more of the concentrated chemicals 120-128 to thereby control the flow rates of the concentrated chemicals, such that a dilution of each concentrated chemical in the motive fluid can be individually controlled in real-time. In some cases, the control unit 105 receives data from each flow rate sensor 110-118 corresponding to an actual flow rate, and when the control unit 105 determines a target flow rate differs from an actual flow rate, the control unit 105 causes a corresponding metering device, e.g., metering device 160, to adjust its rate of dispensing of its corresponding concentrated chemical, e.g., concentrated chemical 120, into the concentrated chemical inlet 151 of the eductor 150 associated therewith. For instance, when the metering device 160 is a pinch valve or a needle valve, an orifice size of the concentrated chemical line 130 may be caused to be adjusted, e.g., larger or smaller, upon the control unit 105 determining the target flow rate differs from the actual flow rate, to thereby adjust the amount of concentrated chemical delivered to the eductor 150. In some examples, in response to receiving the measured flow rate from each flow rate sensor 110-118, the control unit may additionally or alternatively adjust the control signal for operating a valve 173 of the chemical delivery manifold 170 coupled to the motive fluid inlet 153 of the eductor 150.

In further implementations, the dilution control system 100 may additionally include a mixed solution flow rate sensor 180 coupled to the mixed solution line 175, also referred to as a distribution line, and the mixed solution flow rate sensor 180 may measure a flow rate of the mixed solution or the combined mixed solution passing through the mixed solution line 175. In implementations, the mixed solution line 175 may be fluidly coupled to each of the mixed solution outlets 155 of the eductors 150-158 such that each mixed solution from a respective eductor is combined in the mixed solution line 175 to form a combined mixed solution. In this configuration, the mixed solution flow rate sensor 180 may measure the total outlet flow from the chemical delivery manifold 170 of the dilution control system 100. The control unit 105 may receive the measured flow rate from the mixed solution flow rate sensor 180 as well as from the flow rate sensors 110-118 coupled to the in-feed lines 130-138. Based on the measured flow rates, the control unit 105 may cause one or more of the metering devices 160-168 to adjust a flow rate of concentrated chemical through a corresponding in-feed line, e.g., one or more of in-feed lines 130-138. Consequently, a dilution of any or all of the concentrated chemicals in the combined mixed solution may be controlled, in part, based on information from the mixed solution flow rate sensor 180 measuring the total outlet flow from the chemical delivery manifold 170.

In some implementations, the control unit 105 of the dilution control system 100 may be separate from an external controller 201, also located at the same location as the dilution control system 100. The external controller 201 in plant irrigation systems is also known as an irrigation controller. An external controller 201 in vehicle wash settings is also known as a customary car wash controller. Such controllers may operate legacy components of an irrigation operation or a vehicle wash, for examples. In implementations where the dilution control system 100 operates in combination with a customary external controller 201, the external controller 201 may be a customary power source that delivers timed voltage signals to multiple systems in the setting or location where the dilution control system 100 is arranged, including solution delivery systems, and may typically deliver common control voltages of: 24 VAC, 24 VDC, or 120 VAC, ±20% to operate these multiple systems, including fluid management and dilution systems. However, the control unit 105 of the dilution control system 100 may instead interpret the control voltage of the external controller 201 simply as a signal (e.g., a sensed voltage or an on/off signal), and instead of allowing the same signal to be relayed to the chemical delivery manifold 170 or other components of the dilution control system 100, the control unit 105 may interpret the signal (e.g., as a signal meant to perform some action or operation by the dilution control system 100), generate a different control signal and send this to the chemical delivery manifold 170 or other component, such as for dispensing solutions according to the commands of the dilution control system 100. Thus, while the external controller 201 may control the operation of other devices in this setting, the external controller 201 may more simply deliver a signal to the dilution control system 100 for subsequent interpretation by the control unit 105 and action. This configuration may provide the dilution control system 100 autonomy relative to other devices that may be controlled in a customary manner by the external controller 201. A number of components may be controlled by the external controller 201, while dilution control systems (e.g., 100, 100′) provided according to the present disclosure, may operate independently from the external controller's 201 commands.

In implementations where the control unit 105 is programmed to generate a separate signal from the external controller 201, the dilution control system 100 may be operated using different operating parameters relative to the parameters sent by the external controller 201.

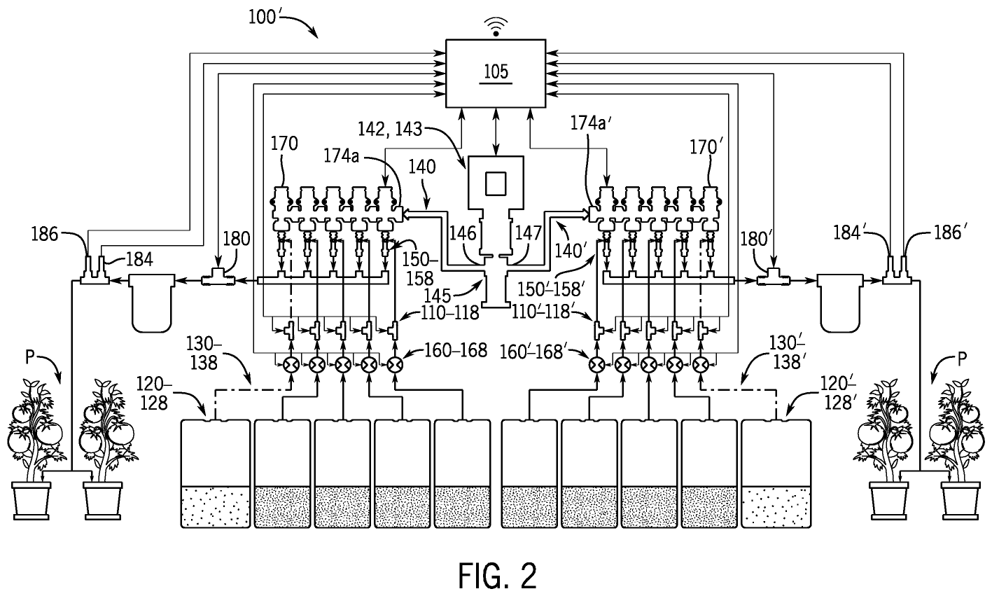

In some implementations, multiple dilution control systems may be provided in a single facility. Turning to FIG. 2, a dilution control system 100′ is illustrated, which may operate multiple sets of fluid delivery components using the control unit 105. The dilution control system 100′ may include multiple sets of substantially the same components as the dilution control system 100 of FIGS. 1A and 1B, while a single control unit 105 is responsible for controlling the components thereof. For instance, the control unit 105 may control flow rate sensors 110-118 and 110′-118′ (e.g., chemical in-flow meters), a plurality of concentrated chemicals 120-128 and 120′-128′ (e.g., agricultural inputs such as nutrients and fertilizers, and pH adjusters) within respective in-feed lines 130-138 and 130′-138′, metering devices 160-168 and 160′-168′ (e.g., pinch valves, needle valves, positive displacement pumps), chemical delivery manifolds 170 and 170′ (e.g., water manifolds), mixed solution flow rate sensors 180 and 180′ (e.g., flow meter outlet flows), pH sensors 184 and 184′, electrical conductivity sensors 186 and 186′ (e.g., EC sensors), eductors 150-158 and 150′-158′, and so on. As shown in FIG. 2, the control unit 105 may operate a single pump 142 of the dilution control system 100′ to deliver fluid pressure to the water inlet lines 140, 140′ in connection with operation of the chemical delivery manifolds 170, 171′, however, it will be appreciated that two or more pumps may be provided in the dilution control system 100′ and for instance, each pump may be configured to deliver fluid pressure to a single set of dilution control system components similar to FIGS. 1A and 1B. In implementations where a single source of fluid delivers water to multiple chemical delivery manifolds 170, 170′, the dilution control system 100′ may include a distribution manifold 145 fluidly coupled between the motive fluid source and the chemical delivery manifolds 170, 170′. For instance, in FIG. 2, the motive fluid source may deliver a single source of motive fluid to the pump 142 and the distribution manifold 145 may be arranged between the pump 142 and the chemical delivery manifolds 170, 170′. The distribution manifold 145 may include a plurality of distribution outlets or ports, e.g., distribution ports 146, 147, and so on. The number of outlet ports may correspond to the number of chemical delivery manifolds in the system 100′ as well as other components at the facility requiring motive fluid. For instance, the distribution ports 146, 147 may be fluidly coupled to inlet port 174a, 174a′ of the chemical delivery manifolds 170, 170′. Pressure regulators, flow meters, or bypass connections to facilitate the supply or regulation of the motive fluid into the dilution control system 100′ may also be included in the distribution manifold 145.

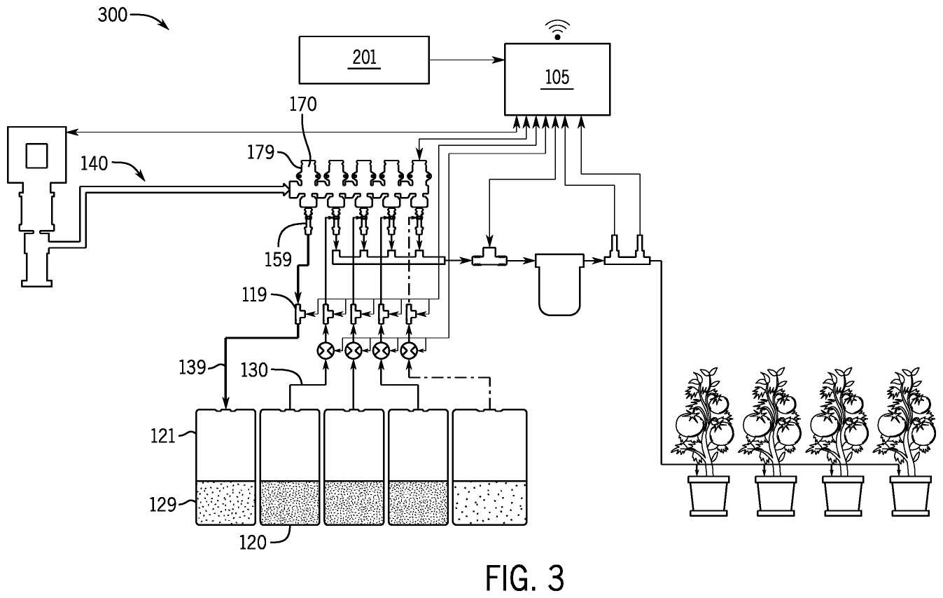

Turning to FIG. 3, illustrated is a dilution control system 300 used for nutrient mixing or reconstitution, in addition to the previously described dilution control. The dilution control system 300 includes substantially the same components as and operates in the same manner as the dilution control system 100 of FIGS. 1A and 1B, and thus many of the commonly shared components are not labeled in FIG. 3. Nutrient mixing using the dilution control system 300 involves delivering the motive fluid from an outlet of the chemical delivery manifold to a mixing station. The mixing station may include a barrel 121 containing dry ingredients 129 or other concentrated components requiring mixing with additional water prior to distribution and dilution in the dilution control system. In FIG. 3, the barrel 121 is fluidly coupled to the water inlet line 140 via the chemical delivery manifold 170 (e.g., water manifold or tank filling and mixing manifold) and a fluid line 139 downstream thereof. For instance, in FIG. 3, the barrel 121 may motive fluid upon actuation of an actuator 179 of the chemical delivery manifold 170, and as water flows past a motive fluid flow rate sensor 119, the flow rate and amount of water delivered to the barrel 121 is sensed. The flow rate and total amount of water delivered to the barrel 121 may be monitored by the control unit 105. The control unit 105 may thus monitor the amount of water combined with the dry ingredients 129, and where the amount of dry ingredients is known, the control unit determines a precise concentration of the dissolved dry ingredients in the water. Typically dry ingredients are mixed with 50 gallons of water to reach a target concentration, however, the skilled artisan understands that more or less water may be added to reach the target concentration. The reconstituted dry ingredients with the known amount of water may then be used as a nutrient supply in the dilution control systems of the present disclosure. For instance, the reconstituted dry ingredients 129 may serve as the concentrated chemical 120, and as provided herein, is received at the in-feed line 130 for subsequent controlled metering into the dilution control systems provided herein. Consequently, the use of the motive fluid flow rate sensor 119 and the control unit 105 to track the amount of water flowing into the barrel 121 provides an accurate and consistent starting point for distribution of the concentrated chemicals into the disclosed dilution control systems.

In some implementations, an eductor 159 may be fluidly coupled between the chemical delivery manifold 170 and the barrel 121, and the eductor may optionally deliver a nutrient or other component into the barrel during reconstitution of the dry ingredients 129.

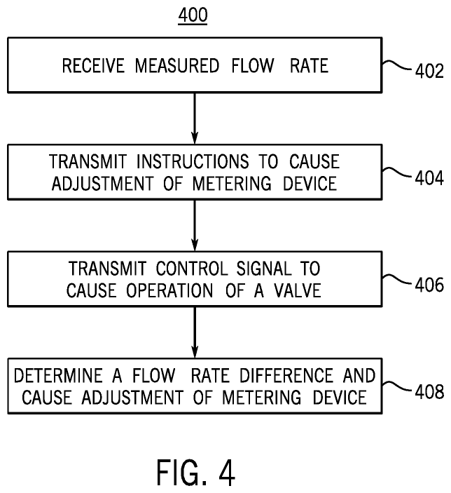

FIG. 4 is a flow chart illustrating a method 400 of delivering a mixed solution from a chemical delivery system configured with dilution control, such as any of the systems provided above. For example, the method 400 may illustrate delivering a mixed solution from the dilution control system 100, the dilution control system 100′, or the dilution control system 300. The method 400 may include receiving a measured flow rate (Block 402). For example, a control unit, such as the control unit 105, may receive a measured flow rate from a plurality of flow rate sensors, such as the flow rate sensors 110, 112, 114, 116, and 118. The method 400 may include transmitting instructions to cause adjustment of a metering device (Block 404). For example, the control unit 105 may transmit instructions to cause at least one metering device of a plurality of metering devices, such as the metering devices 160, 162, 164, 166, and 168, to adjust a rate of dispensing. The method 400 may include transmitting a control signal to cause operation of a valve (Block 406). For example, the control unit 105 may transmit a control signal to a valve, such as the valve 173. The method 400 may include determining a flow rate difference and causing adjustment of the metering device (Block 408). For example, the control unit 105 may determine that the measured flow rate differs from a target flow rate, and based on the determination may cause one or more corresponding metering devices 160, 162, 164, 166, and 168 to adjust the rate of dispensing.

The disclosed embodiments may be combined with the features of the dilution control systems and method of the disclosure of U.S. Publication No. US 2023/0139033 A1, and with features of the sensing and control systems and methods of the disclosure of U.S. Publication No. US 2021/0349482 A1, each of which are incorporated herein by reference for any useful purpose.

Various changes may be made in the form, construction and arrangement of the components of the present disclosure without departing from the disclosed subject matter or without sacrificing all of its material advantages. The form described is merely explanatory, and it is the intention of the following claims to encompass and include such changes. Moreover, while the present disclosure has been described with reference to various embodiments, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

In methodologies directly or indirectly set forth herein, various steps and operations are described in one possible order of operation but those skilled in the art will recognize the steps and operation may be rearranged, replaced, or eliminated without necessarily departing from the spirit and scope of the present disclosure. It is intended that all matter contained in the above description or shown in the accompanying drawings shall be interpreted as illustrative only and not limiting.

What is claimed is:

1. A chemical delivery system with dilution control, comprising:
a chemical delivery manifold comprising a manifold body including an inlet port fluidly coupled to a plurality of eductors, each eductor comprising a motive fluid inlet, a concentrated chemical inlet, and a mixed solution outlet, the motive fluid inlet fluidly coupled to the inlet port and to a valve configured to be operated by a control signal such that each valve is operated independently to selectively control flow of a motive fluid through a respective motive fluid inlet of an eductor of the plurality of eductors, the concentrated chemical inlet fluidly connected to a concentrated chemical by a concentrated chemical line such that each eductor is configured to individually mix a corresponding concentrated chemical into the motive fluid to form a mixed solution therein;
a plurality of metering devices, each coupled to a corresponding concentrated chemical line and configured to control a rate of dispensing of the concentrated chemical passing through the corresponding concentrated chemical line;
a plurality of concentrated chemical flow rate sensors, each coupled to the corresponding concentrated chemical line and configured to measure a flow rate of the concentrated chemical through the corresponding concentrated chemical line; and
a control unit comprising a processor configured to receive a measured flow rate from each flow rate sensor of the plurality of flow rate sensors, and to cause a respective metering device of the plurality of metering devices to adjust the rate of dispensing for one or more of the concentrated chemicals to thereby control the flow rate of the one or more of the concentrated chemicals such that a dilution of each concentrated chemical in the motive fluid is individually controlled.

2. The system of claim 1, wherein the plurality of eductors are configured as venturi eductors, such that the concentrated chemical is drawn through the concentrated chemical inlet by the venturi effect.

3. The system of claim 2, wherein the control unit is configured to receive data from each flow rate sensor of the plurality of flow rate sensors corresponding to an actual flow rate, and when the control unit determines a target flow rate differs from the actual flow rate, the control unit causes a corresponding metering device of the plurality of metering devices to adjust the rate of dispensing of the concentrated chemical into the concentrated chemical inlet.

4. The system of claim 3, wherein the corresponding metering device of the plurality of metering devices is configured to adjust an orifice size of the concentrated chemical line, and wherein when the control unit determines the target flow rate differs from the actual flow rate, the control unit causes the corresponding metering device of the plurality of metering devices to adjust the orifice size of the concentrated chemical line.

5. The system of claim 1, wherein the manifold body comprises a common inlet channel fluidly coupled to each of the valves and to each of the motive fluid inlets of the plurality of eductors.

6. The system of claim 1, wherein the motive fluid is delivered at a constant pressure through each valve.

7. The system of claim 6, wherein the motive fluid is delivered by a supply pump.

8. The system of claim 6, wherein the valve is a pneumatic valve or a solenoid valve.

9. The system of claim 1, wherein in response to receiving the measured flow rate from each flow rate sensor, the control unit is further configured to adjust the control signal for operating the valves coupled to the motive fluid inlet of the eductor.

10. The system of claim 1, further comprising a distribution manifold comprising an inlet port and a plurality of distribution ports, wherein at least one of the plurality of distribution ports delivers the motive fluid to the inlet port of the chemical delivery manifold.

11. The system of claim 10, wherein the chemical delivery system comprises at least two chemical delivery manifolds, and wherein the plurality of distribution ports deliver the motive fluid to each inlet port of the at least two chemical delivery manifolds.

12. The system of claim 1, further comprising a plurality of fluid delivery lines, each fluid delivery line fluidly coupled to an individual mixed solution outlet, wherein the plurality of fluid delivery lines are configured to direct the mixed solution to an application area.

13. The system of claim 12, wherein each fluid delivery line is fluidly coupled to a mixed solution distribution port and configured to deposit the individual mixed solution at the application area.

14. A method of delivering a mixed solution from a chemical delivery system configured with dilution control, comprising:
receiving, by a control unit comprising a processor, measured flow rates from a plurality of flow rate sensors of the chemical delivery system, each of the plurality of flow rate sensors coupled to a corresponding concentrated chemical line and configured to measure a flow rate of a concentrated chemical therethrough, each concentrated chemical line being fluidly coupled to a concentrated chemical inlet of an eductor of a plurality of eductors, wherein each of the plurality of eductors are fluidly coupled to an inlet port of a chemical delivery manifold via a motive fluid inlet thereof, said motive fluid inlet fluidly coupled to a valve of a plurality of valves, and wherein each of the plurality of eductors comprises a mixed solution outlet;
transmitting, by the control unit, instructions to cause at least one metering device of a plurality of metering devices to adjust a rate of dispensing of the concentrated chemical through the corresponding concentrated chemical line for at least one of the concentrated chemicals based on the measured flow rates, wherein each of the plurality of metering devices is coupled to the corresponding concentrated chemical lines and configured to control a rate of dispensing of the concentrated chemical passing therethrough; and
transmitting, by the control unit, a control signal to cause each valve of the plurality of valves to be operated, such that each valve is operated independently to selectively control flow of a motive fluid through a respective motive fluid inlet of an eductor of the plurality of eductors such that each eductor is configured to individually mix the concentrated chemical into the motive fluid to form a mixed solution having a controlled flow rate of the concentrated chemical to thereby individually control a dilution of each concentrated chemical in the motive fluid.

15. The method of claim 14, further comprising, determining, by the control unit, that the measured flow rate from one or more flow rate sensors differs from a target flow rate; and based on the determination, causing, by the control unit, one or more corresponding metering devices of the plurality of metering devices to adjust the rate of dispensing of the concentrated chemical.
